(19) United States
(12) Patent Application Publication
(10) Pub. No.: US 2011/0289541 A1
(43) Pub. Date: Nov. 24, 2011

(54) PORTABLE SET-TOP BOX

(76) Inventor: Tzu-Chiang Yen, Hsinchu City (TW)

(21) Appl. No.: 13/090,273

(22) Filed: Apr. 20, 2011

(30) Foreign Application Priority Data
May 18, 2010 (TW) 099115789

(51) Int. Cl. H04N 7/173

(52) U.S. Cl. 725/110

(57) ABSTRACT

A portable set-top box includes a network connecting module, an AV receiving module, an information receiving module, a AV display module and a controlling module. The network connecting module is utilized for building up a network connection. The AV receiving module is utilized for receiving an AV signal. The information receiving module is utilized for receiving an information from Internet, local PCs, or machines, including sensor devices and peripherals. The AV display module is coupled to the AV receiving module and the information receiving module, and utilized for driving an external display device to display the information or the AV signal. In addition, the controlling module is coupled to the network connecting module and the information receiving module, and utilized for controlling that the information is transmitted via the network connection.

### BACKGROUND OF THE INVENTION

1. Field of the Invention

The present invention relates to a set-top box, and more particularly, to a portable set-top box with a router function.

2. Description of the Prior Art

The major functionality of a conventional digital set-top box (STB) is to provide video services to household. For example, if a user desires to watch TV/Video programs at home, he/she can have the STB connected to TV to access digital content.

Nowadays, there are already numerous products related to the set-top box on the market, but not equipped with a router function in order to perform interactions with home network equipments, sensing devices (such as, a wireless device, a Bluetooth device, or a RF device). Integrating STB with IP routing capability together will make it convenient to the user who needs to update or manage the latest information of abovementioned devices from TV screen or communicate with service providers via Internet. Furthermore, the conventional STB must be placed in a fixed location and cannot be moved between rooms or even outside home, thus, the user is unable to carry the STB around and not able enjoy the subscribed digital content when the user is on the road.

Hence, how to improve the service scenario of the STB, and provision more personalized applications to the STB become important topics in this field.

### SUMMARY OF THE INVENTION

It is one of the objectives of the claimed invention to provide a portable set-top box to solve the abovementioned problems.

According to one embodiment, a portable set-top box is provided. The portable set-top box includes a network connecting module, an AV receiving module, an information receiving module, a AV display module and a controlling module. The network connecting module is utilized for building up a network connection. The AV receiving module is utilized for receiving an AV signal. The information receiving module is utilized for receiving an information from Internet, local PCs, or machines, including sensor devices and peripherals. The AV display module is coupled to the AV receiving module and the information receiving module, and utilized for driving an external display device to display the information or the AV signal. In addition, the controlling module is coupled to the network connecting module and the information receiving module, and utilized for controlling that the information is transmitted via the network connection.

In one embodiment, the information receiving module includes a USB device for receiving the information.

In another embodiment, the AV display module includes an AV port (e.g., a HDMI port), for outputting the AV signal to the external display device.

In another embodiment, the network connecting module has a router function.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a portable set-top box according to a first embodiment of the present invention.

FIG. 2 is a diagram illustrating an embodiment of the application architecture of the portable set-top box shown in FIG. 1.

FIG. 3 is a block diagram of a portable set-top box according to a second embodiment of the present invention.

FIG. 4 is a block diagram of a portable set-top box according to a third embodiment of the present invention.

FIG. 5 is a block diagram of a portable set-top box according to a fourth embodiment of the present invention.

### DETAILED DESCRIPTION

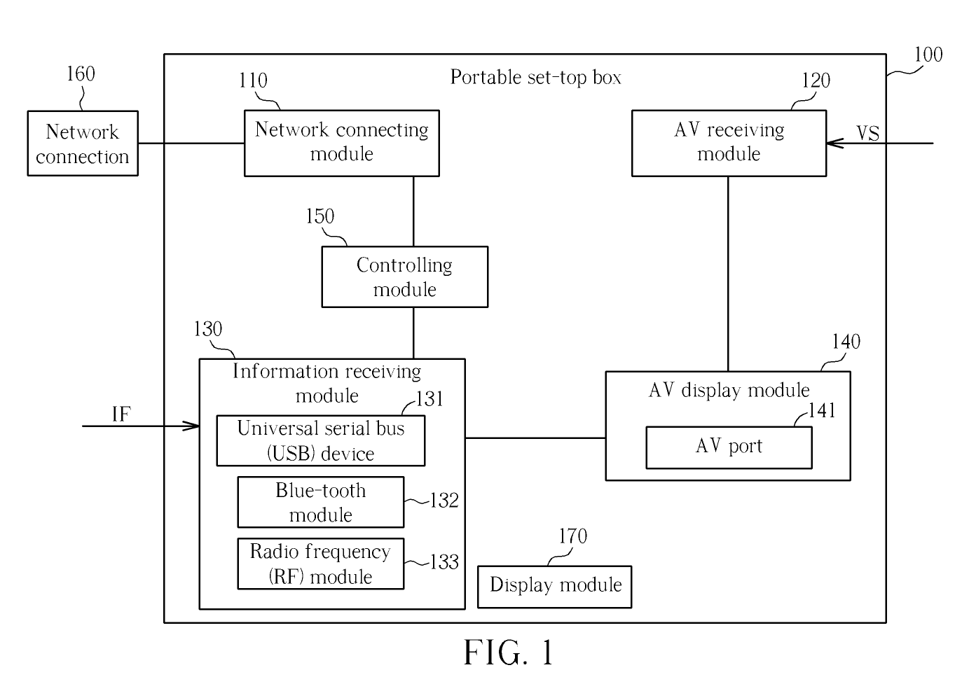

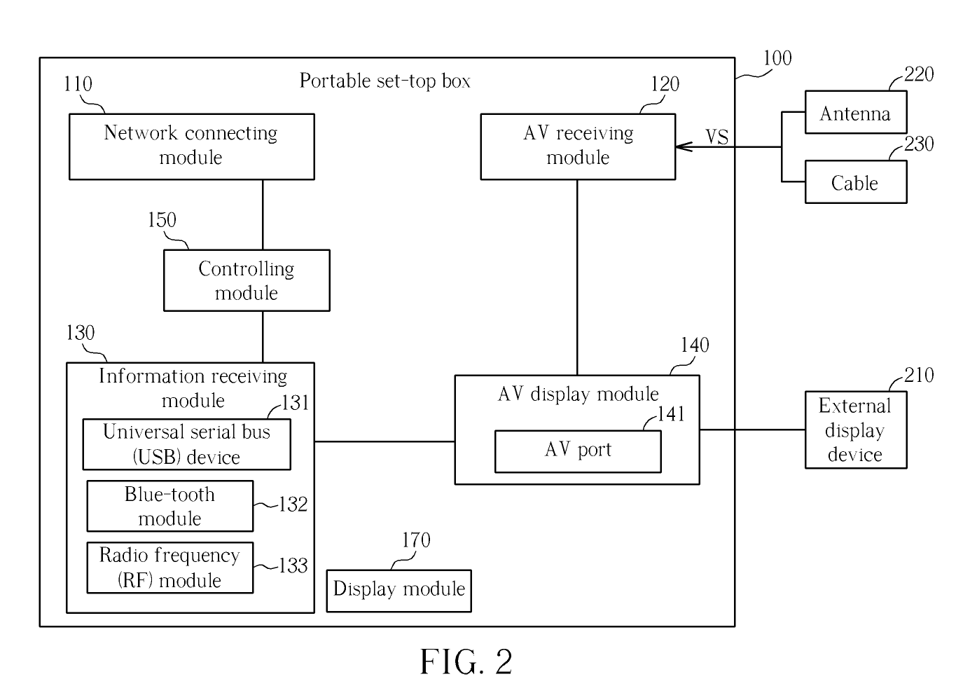

Please refer to FIG. 1 together with FIG. 2. FIG. 1 is a block diagram of a portable set-top box 100 according to a first embodiment of the present invention. FIG. 2 is a diagram illustrating an embodiment of the application architecture of the portable set-top box 100 shown in FIG. 1. As FIG. 1 depicts, the portable set-top box 100 includes, but is not limited to, a network connecting module 110, an audio and video (AV) receiving module 120, an information receiving module 130, an AV display module 140, and a controlling module 150. The network connecting module 110 is utilized for building up a network connection 160. The AV receiving module 120 is utilized for receiving an AV signal AVS via an antenna or a cable, such as the antenna 220 or the cable 230 shown in FIG. 2. The information receiving module 130 is utilized for receiving an information IF from Internet, local PCs, or machines, including sensor devices and peripherals. The AV display module 140 is coupled to the AV receiving module 120 and the information receiving module 130, for driving an external display device (such as the external display device 210 shown in FIG. 2) to display the information IF or the AV signal AVS. In addition, the controlling module 150 is coupled to the network connecting module 110 and the information receiving module 130, for controlling that the information IF is transmitted via the network connection 160.

Please note that in one embodiment, the above-mentioned information receiving module 130 may include a universal serial bus (USB) device 131, a blue-tooth module 132 and a radio frequency (RF) module 133, for receiving the information IF, but this is not meant to be a limitation of the present invention. That is to say, the USB device 131, the blue-tooth module 132, and the RF module 131 are merely optional components, which can be determined whether to be disposed depending upon designs and actual applications. Furthermore, the AV display module 140 may have an AV port 141, such as a high density multimedia interface (HDMI) port, for outputting the AV signal AVS to the external display module 210. Similarly, the AV port 141 is also an optional component, which can be determined whether to be disposed depending upon designs and actual applications. Additionally, the AV signal AVS can be an AV stream, and the AV receiving module 130 can receive the AV stream via the network connection 160, but the present invention is not limited to this only.

As an illustration, the information IF may include a blood pressure data or a blood glucose data. If a user has demands for monitoring the blood pressure data or the blood glucose data, he can use the information receiving module 130 to receive the blood pressure data or the blood glucose data and then transmit the data to a server via the network connection 160.

As another illustration, the information IF may include an AV data. After a user uses a camera to capture pictures, he can use the information receiving module 130 to receive the AV data from the camera and then use the AV display module 140 to display the AV data on the external display device 210.

As still another illustration, the information IF may include a power consumption information. A user can use the information receiving module 130 to receive the power consumption information from household appliances, and then use the AV display module 140 to display the power consumption information on the external display device 210. As a result, the user is able to manage the power consumption information in order to optimize the power consumption, and thereby reduce energy waste and improve energy efficiency. Please note in another embodiment of the present invention, the power consumption information can be transmitted to the power company via the network connection 160 for effective power management, and thereby replace manual meter readings so as to achieve a smart grid function.

Please note that if the user's device (the blood pressure monitor, or glucose meter, or the camera) is equipped with a USB device, a blue-tooth module or an RF module, the present invention can use the USB device 131, the blue-tooth module 132 or the RF module 133 of the information receiving module 130 to receive the blood pressure data, the blood glucose data or the AV data. Operations of the USB device, the blue-tooth module, and the RF module are already well-known to those skilled in the art, and further description is omitted here for brevity.

Moreover, in one embodiment, the network connecting module 110 may have a router function. Hence, if the user's device (the blood pressure monitor, the glucose meter, the camera or the household appliances) is equipped with a LAN module (e.g., an Wi-Fi network), the present invention can use the network connecting module 110 to receive the blood pressure data, the blood glucose data, or the AV data.

Please also note that, during the operation of receiving the information IF in the present invention, the user can output the received information IF to the external display device 210 via the AV display module 140, and thereby provide interactive functions to the user. Therefore, the receiving procedure of the information IF can be clearly known by the user via the external display device 210.

What calls for special attention is that the network connecting module 110 may build up the network connection 160 by using a wired network or a wireless network. For example, in one embodiment, the network connecting module 110 may include a modem (not shown), and the user can use the modem to build up the network connection 160. The modem can conform to a digital subscriber line (DSL) application (e.g., ADSL or VDSL), a CABLE specification, a fiber optical specification, a 3G mobile communication standard, or a 4G mobile communication standard. This in no way should be considered as limitations of the present invention. As one skilled in the art will readily appreciate that any type of modem capable of building up a network connection can be adopted, which also belongs to the scope of the present invention.

Please also note that: in order to show the current status of the portable set-top box 110 or the information IF received by the information receiving module 130 or the AV signal AVS received by the AV receiving module 120, a display module 170 (e.g., an LED module or an LCD module) may be disposed in the portable set-top box 100 of the present invention. However, this is merely a practicable embodiment of the present invention, and should not be considered as a limitation of the present invention. In other words, the display module 170 is merely an optional component, which can be determined to be disposed depending upon designs and actual applications.

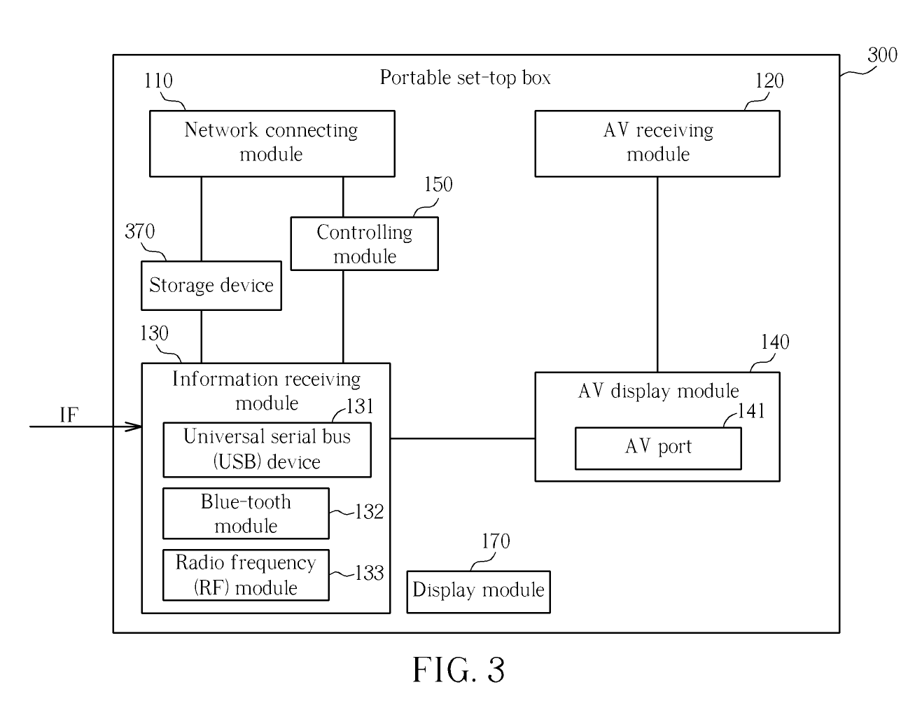

Please refer to FIG. 3. FIG. 3 is a block diagram of a portable set-top box 300 according to a second embodiment of the present invention. The architecture of the portable set-top box 300 shown in FIG. 3 is similar to that of the portable set-top box 100 shown in FIG. 1, and the major difference between them is that the portable set-top box 300 further includes a storage device 370 (e.g., a flash memory) coupled to the information receiving module 130, for storing the information IF received by the information receiving module 130.

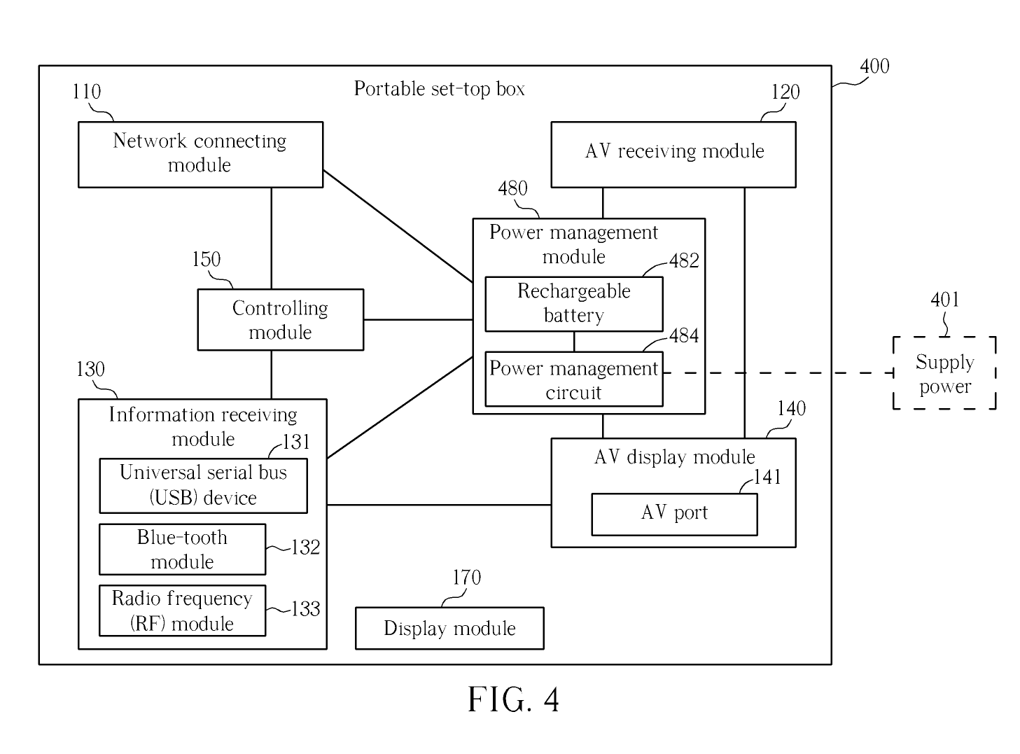

Please refer to FIG. 4. FIG. 4 is a block diagram of a portable set-top box 400 according to a third embodiment of the present invention. The architecture of the portable set-top box 400 shown in FIG. 4 is similar to that of the portable set-top box 100, and the major difference between them is that the portable set-top box 400 further includes a power management module 480 being at least coupled to the network connecting module 110, the AV receiving module 120, the information receiving module 130, the AV display module 140, and the controlling module 150, for providing supply powers to these internal components (e.g., 110˜150) of the portable set-top box 400. In this embodiment, the power management module 480 may include a rechargeable battery 482 and a power management circuit 484. Herein the rechargeable battery 482 is used for providing supply powers to those components 110˜150; and the power management circuit 484 is coupled to the rechargeable battery 482, for controlling the rechargeable battery 482 to store the supply power 401 (e.g., an Electricity with 110V) externally connected to the power management module 480. However, the portable set-top box 400 shown in FIG. 4 is merely a practicable embodiment of the present invention, and in no way should be considered as a limitation of the present invention. In other embodiments, the power management module 480 can implemented by a common battery only so as to provide supply powers to those components 110˜150. That is to say, the power management circuit 484 can be omitted in the power management module 480, and the rechargeable battery 482 can be replaced by a common battery, which also belongs to the scope of the present invention.

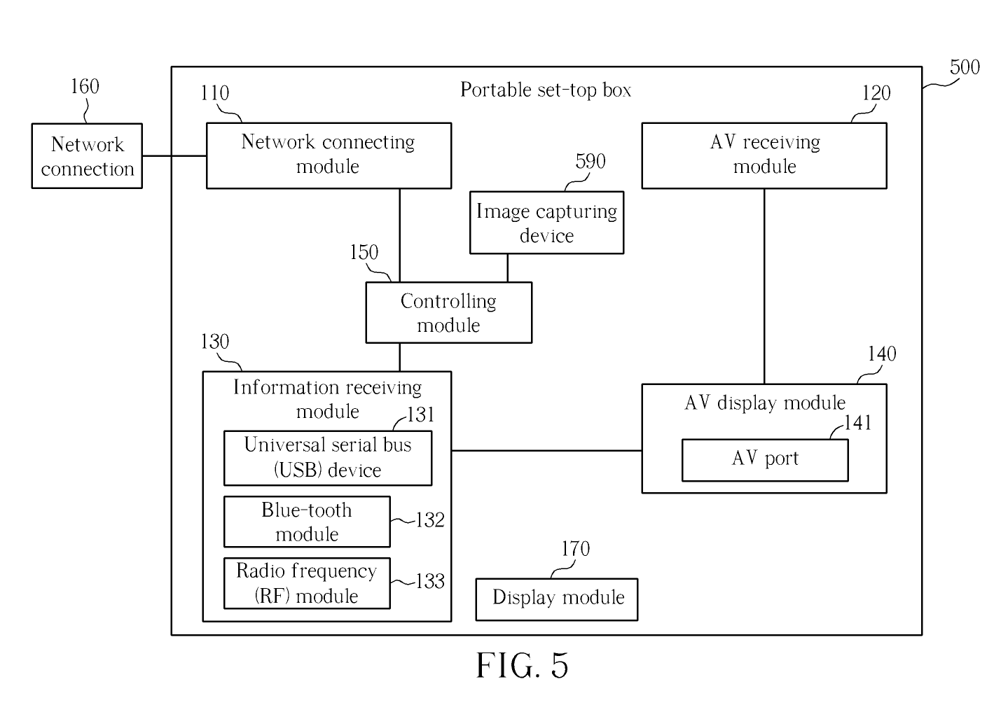

Please refer to FIG. 5. FIG. 5 is a block diagram of a portable set-top box 500 according to a fourth embodiment of the present invention. The architecture of the portable set-top box 500 shown in FIG. 5 is similar to that of the portable set-top box 100 shown in FIG. 1, and the major difference between them is that the portable set-top box 500 further includes an image capturing device 590, for capturing an image frame. In this embodiment, the controlling module can be further used for transmitting the image frame captured by the image capturing device 590 via the network connection 160 so as to perform a video access grid.

The abovementioned embodiments are presented merely to illustrate practicable designs of the present invention, and in no way should be considered to be limitations of the scope of the present invention. Those skilled in the art should appreciate that various modifications of the portable set-top boxes 100, 300, 400, and 500 shown in FIG. 1-FIG. 5 may be made without departing from the spirit of the present invention. For example, the portable set-top boxes shown in FIG. 1-FIG. 5 can be arranged or combined randomly into a new varied embodiment.

From the above descriptions, the present invention provides a portable set-top box, which can be dependently used as a single set-top box or a single router. In other words, by combining the set-top box together with the router, the portable set-top box is able to be equipped with the router function, and thereby achieve a goal of portable uses. Additionally, the portable set-top box disclosed in the embodiments of the present invention can provide interactive functions to the user, and thus the user can update or modify the latest information timely. Moreover, a power management module (e.g., a battery which can be implemented by a rechargeable battery or a common battery) can be disposed in the portable set-top box, in order to improve the convenience of the portable set-top box. Or an image capturing device can be further disposed in the portable set-top box so as to give additional applications to the portable set-top box.

Those skilled in the art will readily observe that numerous modifications and alterations of the device and method may be made while retaining the teachings of the invention.

What is claimed is:

1. A portable set-top box, comprising:
a network connecting module, for building up a network connection;
an audio and video (AV) receiving module, for receiving an AV signal;
an information receiving module, for receiving an information;
a AV display module, coupled to the AV receiving module, for driving an external display device to display the information or the AV signal; and
a controlling module, coupled to the network connecting module and the information receiving module, for controlling that the information is transmitted via the network connection.

2. The portable set-top box of claim 1, wherein the information receiving module comprises:
a universal serial bus (USB) device, a blue-tooth module or a radio frequency (RF) module, for receiving the information.

3. The portable set-top box of claim 1, wherein the AV receiving module receives the AV signal via an antenna or a cable.

4. The portable set-top box of claim 1, wherein the AV display module comprises:
an AV port, for outputting the AV signal to the external display device.

5. The portable set-top box of claim 4, wherein the AV port is a high density multimedia interface (HDMI) port.

6. The portable set-top box of claim 1, wherein the AV signal is an AV stream, and the AV receiving module receives the AV stream via the network connection.

7. The portable set-top box of claim 1, further comprising:
a power management module, coupled to the network connecting module, the AV receiving module, the information receiving module, the AV display module, and the controlling module, for providing supply powers to the network connection module, the AV receiving module, the information receiving module, the AV display module, and the controlling module.

8. The portable set-top box of claim 7, wherein the power management module comprises:
a battery, for providing supply powers to the network connecting module, the AV receiving module, the information receiving module, the AV display module, and the controlling module.

9. The portable set-top box of claim 8, wherein the battery is a rechargeable battery, and the power management module further comprises:
a power management circuit, coupled to the rechargeable battery, for controlling the rechargeable battery to store a supply power externally connected to the power management module.

10. The portable set-top box of claim 1, further comprising:
a storage device, for storing the information received by the information receiving module.

11. The portable set-top box of claim 10, wherein the storage device is a flash memory.

12. The portable set-top box of claim 1, further comprising:
an image capturing device, for capturing an image frame;
wherein the controlling module is further utilized for transmitting the image frame captured by the image capturing device via the network connection so as to perform a video access grid.

13. The portable set-top box of claim 1, wherein the network connecting module builds up the network connection by using a wired network.

14. The portable set-top box of claim 1, wherein the network connecting module builds up the network connection by using a wireless network.

15. The portable set-top box of claim 14, wherein the network connecting module comprises a modem; and the portable set-top box builds up the network connection via the modem.

16. The portable set-top box of claim 15, wherein the modem conforms to a digital subscriber line (DSL) application, a cable specification, a fiber optical specification, a 3G mobile communication standard, or a 4G mobile communication standard.

17. The portable set-top box of claim 1, wherein the network connecting module has a router function.

18. The portable set-top box of claim 1, further comprising:
a display module, for displaying a current status of the portable set-top box or for displaying the information or the AV signal.

19. The portable set-top box of claim 18, wherein the display module is a light emitting diode (LED) module or a liquid crystal display (LCD) module.

20. The portable set-top box of claim 1, wherein the information is a AV data, a power consumption information, a blood pressure data or a blood glucose data.
